(19) United States
(12) Patent Application Publication
(10) Pub. No.: US 2007/0162487 A1
(43) Pub. Date: Jul. 12, 2007

(54) Multi-format data coding, managing and distributing system and method

(75) Inventor: John W. Frailey, Kansas City, MO (US)

Correspondence Address: MARK BROWN, 4700 BELLEVIEW SUITE 210, KANSAS CITY, MO, 64112, US

(73) Assignee: RazorStream, LLC

(21) Appl. No.: 11/323,768

(22) Filed: Dec. 30, 2005

(51) Int. Cl. G06F 7/00

(52) U.S. Cl. 707/102

(57) ABSTRACT

A multi-format data coding, managing and distributing system includes a data center with a server including an extensible video engine (EVE), which is adapted for transcoding video content into multiple formats. A method of the present invention includes the steps of creating, uploading, transcoding and distributing video content. The content is managed by the system and method, including storage in a video vault.

### BACKGROUND OF THE INVENTION

1. Field of the Invention

The present invention relates generally to data coding, managing and distributing, and in particular to an agnostic system and method for transcoding and managing video content in multiple formats. The video content is distributed to users with various viewing systems.

2. Description of the Related Art

Electronic communications and transactions commonly involve transmitting data between and among content providers and users. Such communications and transactions are dependent upon the data being properly formatted for user accessibility. For example, various video data formats and protocols are commonly used, including Real, Quicktime, Flash and Windows Media. Such formats have different system requirements and performance characteristics. For example, bandwidths and bit rates vary from system-to-system and significantly effect performance.

Video content providers often find it necessary to convert their files to these and other formats through translating and encoding procedures, which are collectively referred to as “transcoding”. However, transcoding with previous techniques tended to be time-consuming and inefficient. Consequently, communications and transactions involving video content have not achieved their full potential or reached certain market segments. In addition to equipment considerations, video content transfer is affected by the broadcast and distribution systems, which can comprise e-mail, hypertext transfer protocol (“http”), worldwide web (“Internet”) and various network (e.g. LAN, WAN, wired, wireless, etc.) systems. A data system for creating, managing and distributing video content would preferably universally accommodate multiple broadcast and distribution systems, which use various players, protocols and formats.

System performance characteristics tend to be relatively important when dealing with video files because they are normally quite large and require powerful computer systems for creating, storing, coding and distributing their contents. They also tend to occupy relatively large amounts of disk space. Video files are often compressed using well-known techniques to facilitate their efficient storage and transfer.

High-resolution, fast video access and playback are in demand for many streaming and store-and-forward applications and markets. However, heretofore there has not been available a system and method for coding, managing and distributing data, particularly video, in multiple formats with the advantages and features of the present invention.

### SUMMARY OF THE INVENTION

In the practice of an aspect of the present invention, a system and method are provided for coding, managing and distributing data in multiple formats for use by recipients with equipment having various characteristics. Such equipment characteristics can include formats, bitrates and codecs. A data center includes an auto-provisioning server, which is scalable by adding blades for designated functions. The server includes an extensible video engine (EVE), which provides transcoding functions among multiple formats. The server can detect player and bitrate characteristics of users'/viewers' target equipment for purposes of distributing appropriately transcoded content.

### BRIEF DESCRIPTION OF THE DRAWINGS

FIG. 1 is a block diagram of a system embodying the present invention.

FIG. 2 is a block diagram of a primary data center of the present invention.

FIG. 3 is a block diagram of a third-party data center of the present invention.

FIG. 4 is a block diagram of a client browser of the present invention.

FIG. 5 is a flowchart of a method to embodying an aspect the present invention.

FIG. 6 is a block diagram of components of the system involved in video creation and consumption.

FIG. 7 is a diagram of a rack portion of a server including multiple blades.

FIG. 8 is a table of various blade functions.

FIGS. 9-31 are screen captures showing the operation of the system and method.

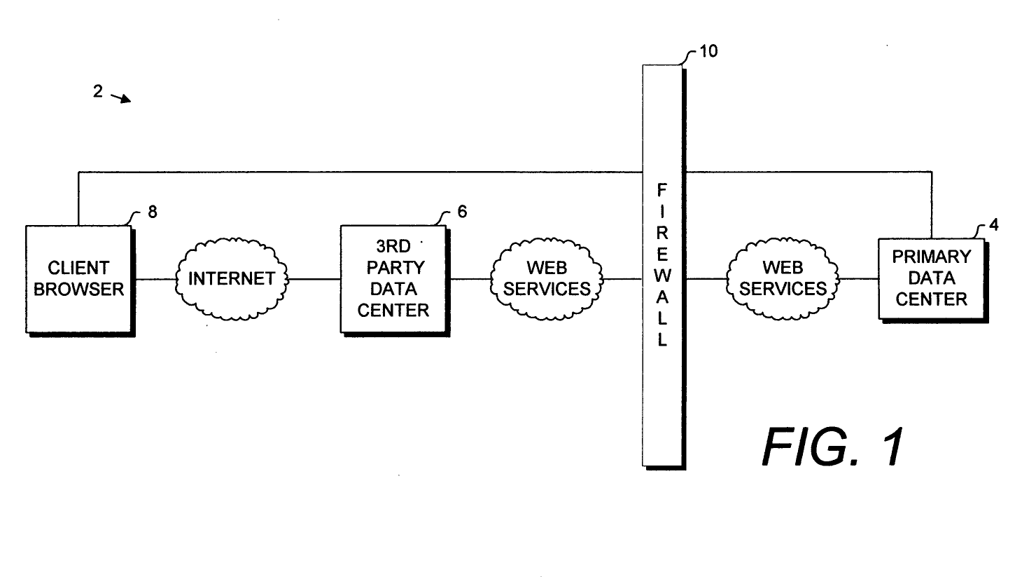

### DETAILED DESCRIPTION OF THE PREFERRED EMBODIMENTS

I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Certain terminology will be used in the following description for convenience in reference only and will not be limiting. Said terminology will include the words specifically mentioned, derivatives thereof and words of similar meaning.

Referring to the drawings in more detail, the reference numeral 2 generally designates a multi-format data coding, managing and distributing system embodying the present invention. Without limitation on the generality of useful forms of data for coding, managing and distributing by the present invention, the system 2 is useful with video content, which will be described herein as a non-limiting example. The system 2 generally includes a data center 4, optional third-party data centers 6 and client browsers 8. Connections can be provided by client hypertext transfer protocol (http), worldwide web (Internet), streaming and other suitable connections, which can pass through suitable firewalls 10 and other protective filters.

II. Data Center 4

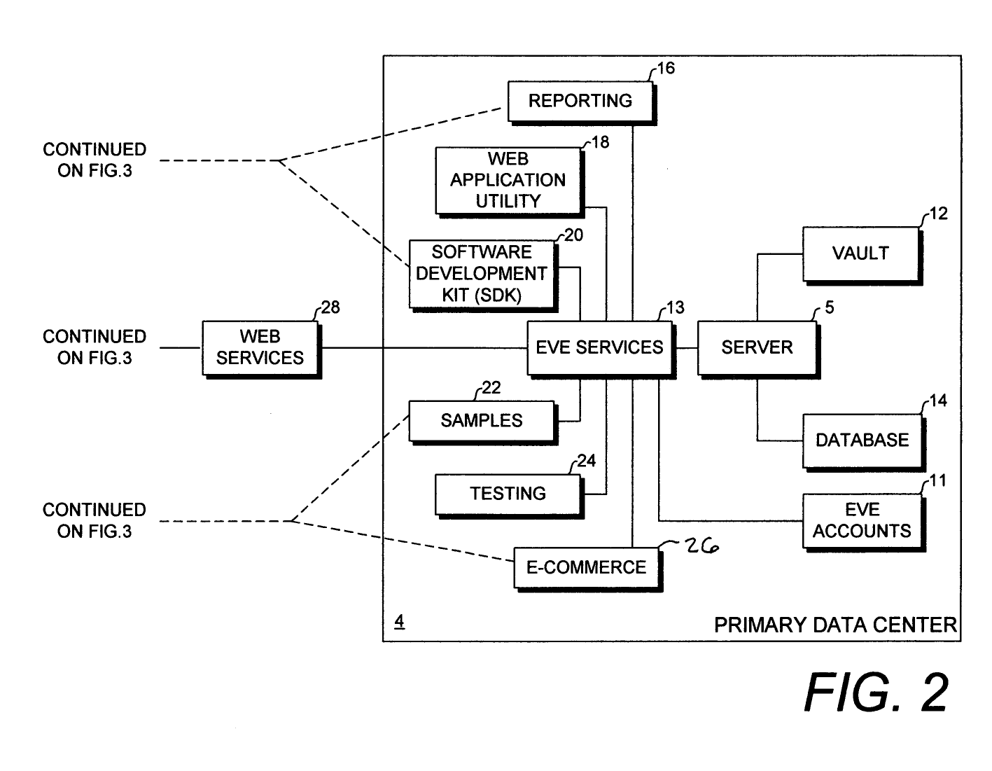

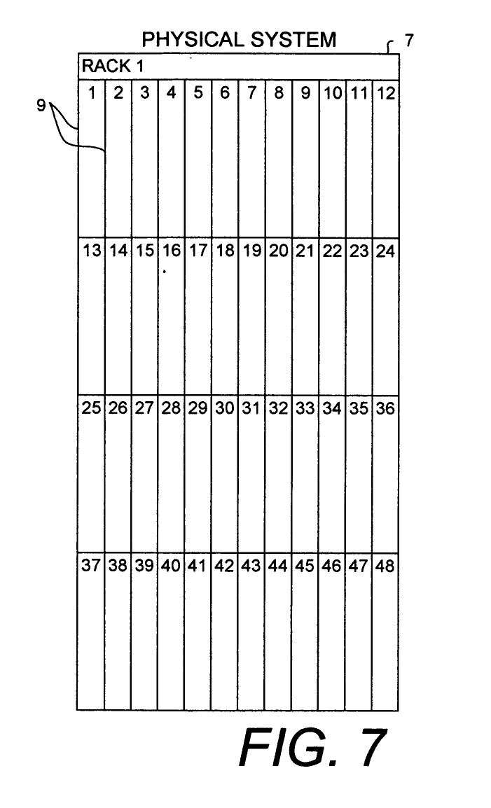

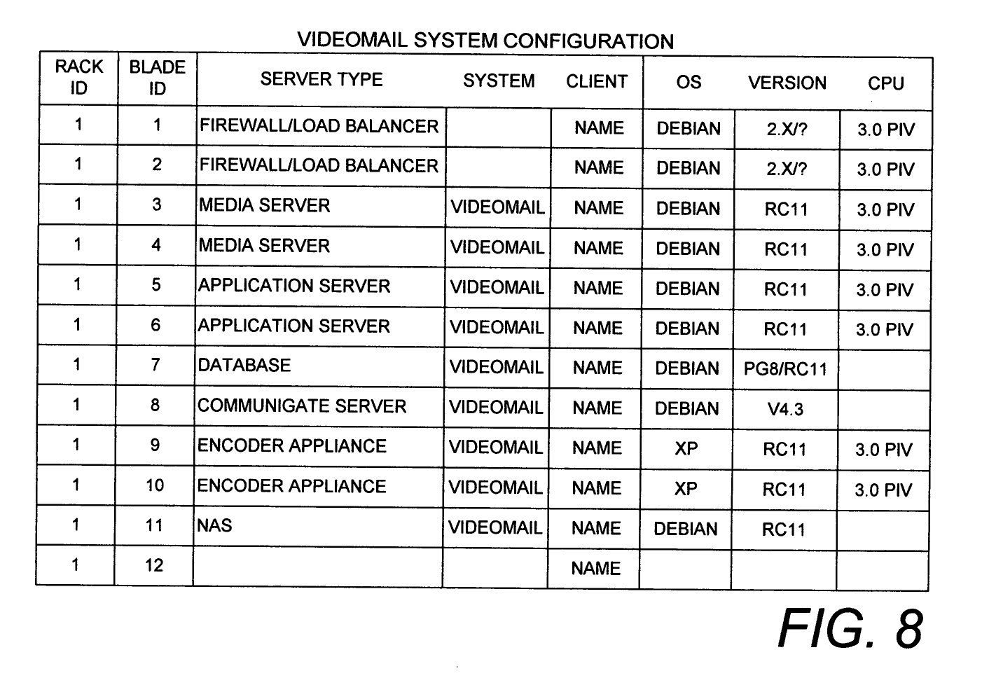

As shown in FIG. 2, the data center 4 can comprise multiple devices or appliances, and provide multiple functionalities. An extensible video engine (EVE) generally comprises software installed on a server 5. For purposes of effectively handling video content in multiple formats from multiple clients, and distributing same to users with various players, bandwidths and bit rates, the server 5 is preferably scalable and auto-provisioning. Scalability can be achieved, for example, with a rack-mountable server holding a series of small blade computers. FIG. 7 is a physical system diagram generally showing the chassis 7 of the server 5 with multiple blades (i.e., small form factor computers) 9, which are assigned various functions according to the videomail system configuration table shown in FIG. 8. For example, the blades 9 can be assigned functions such as firewall load balancer, media server, application server, database, communigate server, encoder appliances and network-attached storage (NAS). The blades 9 can utilize appropriate operating systems, CPUs, etc. Auto-provisioning of server 5 resources automatically accommodates various tasks and operations by distributing and balancing computational functions among the blades and other system resources. Scalability is achieved by adding computational resources, such as additional blades 9.

The server 5 provides EVE services at 13, which are generally utilized by the EVE accounts 11. The EVE accounts 11 can include, for example, video content providers. The content can be stored in a media (e.g. video) vault 12 for access by the EVE server 5. A database 14 is also connected to and accessible by the server 5, and can contain, for example, account and transaction records.

Without limitation on the generality of useful functions and services provided by the EVE system, FIG. 2 shows several examples, including reporting 16 whereby account and client reports can be produced and distributed. Such reports can provide full breakdowns of activity over specified billing periods, histories of service, Akami (or equivalent) backfeed reports, links, statistical data including performance statistics (quality of service of viewers' experience), bandwidth usage, number of users, video format popularities, browsers, operating systems, bitrates, pricing calculations for real-time and day-to-day invoices, pricing projections and usage calculations.

Web application utility services 18 generally enable the EVE accounts 11 to manage their content through such functions as viewing the media vault 12 via customer authentication, creating and uploading media, playback (preview) media, generating HTML on publishing content, web management of profiles, public homepage for sending RSS subscription information to prospective accounts, player skinning graphics and management of the button controls. For example, content creation functions can include web service call up and HTML block back for provisioning audio/video recorders, future audio-only recorders (e.g., Java) and provisioning future flash audio/video recorders. Content management can include Web services calls to published public programming methods such as Application Program Interface (API).

Development services 20 enable various development functions for the accounts 11. For example, utilities can be provided to assist accounts 11 with generating code for integration of external applications into web services. Instruction, links to other resources, bandwidth detection techniques and player detection techniques can be provided for download or access, as appropriate. The EVE services 13 can also include samples 22 for use by developers and others. Testing 24 can comprise a complete test suite of server unit testing, e.g. for educating account implementers and enabling subscriber certification of online applications. Performance utilities for application programmers tuning and setting expectations can also be provided in connection with testing. E-commerce is provided at 26 for conducting various Internet-based transactions associated with the system 2. For example, links can be provided to vendors of various goods and services. Other EVE services can be provided to accounts, developers, implementers, customers, clients and vendors utilizing the system 2. Web services 28 are accessed via the EVE services 13 for providing content over an Internet connection.

III. Third Party Data Centers 6

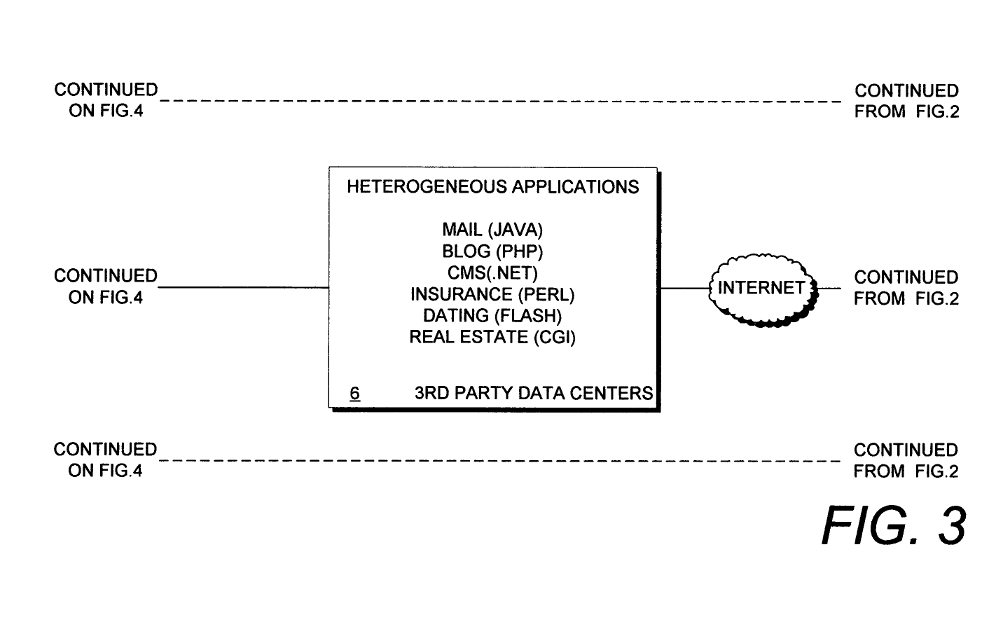

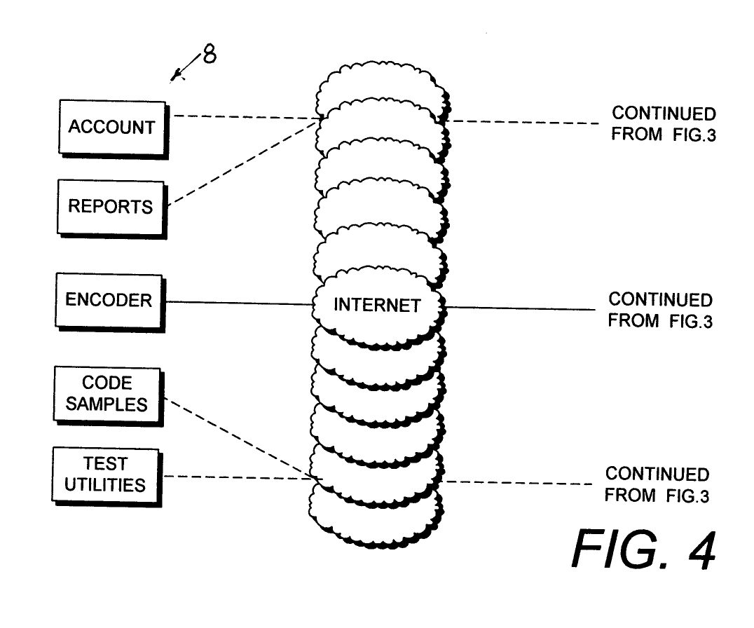

FIG. 3 shows the optional third party data centers 6, comprising exemplary, nonlimiting heterogeneous applications, which can be accessed over the Internet. As shown, the third party data centers 6 can be bypassed by http links to client browsers 8 (FIG. 4). Exemplary heterogeneous applications are shown with corresponding, exemplary software implementation and include mail (Java), blog (PHP), CMS (.net), insurance (PERL), dating (Flash) and real estate (CGI). Such third party data centers 6 can be used by clients of the system 2 for providing similar services to the EVE services 13 associated with the primary data center 4. Via an Internet connection, content can be loaded into and extracted from the vault 12 and transcoded by the server 5. The heterogeneous character of the third party data centers 6 means that various video formats can be utilized and accommodated by the transcoding function of the server 5 in order to accommodate a very large number of customers.

Simple object platform (SOAP) heterogeneous web services can be utilized in connection with providing the content to the third party data centers.

IV. Client Browsers 8

FIG. 4 shows the client and end user functions of the system 2, including direct applications such as accounts and reports, third party applications utilizing an encoder and developer functions such as code samples and test utilities.

V. Multiple Format Video Handling Method

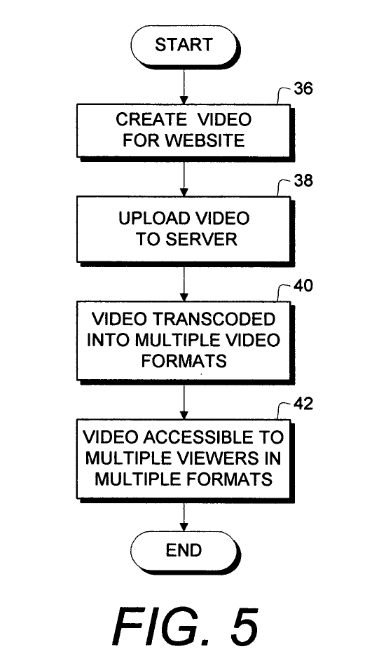

FIG. 5 is a flow diagram generally showing the method of the present invention, commencing with creating video content for a website at 36. The heterogeneous nature of the system 2 facilitates video content creation in various formats whereby the potential client base of content providers is virtually unlimited. The video content is uploaded to the server 5 at step 38 for transcoding into multiple video formats at step 40 and thereafter made accessible to multiple viewers in multiple formats at step 42.

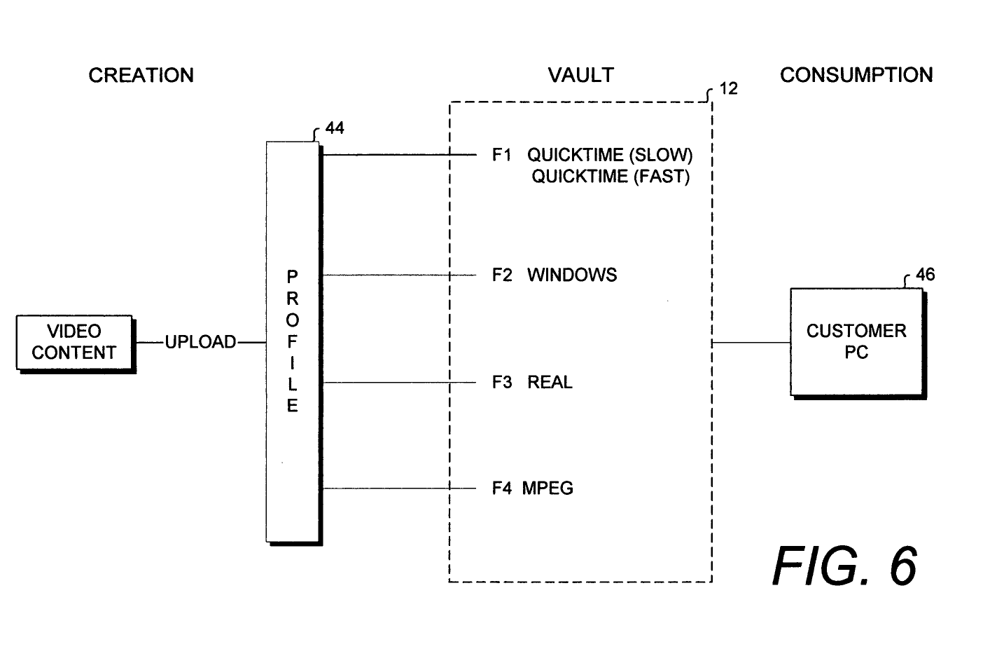

FIG. 6 shows the uploading and transcoding steps 38, 40 in greater detail. More specifically, a profile is provided at 44 and can include, for example, the preferred format(s) for the video content transcoding and preferences for such variables as player type, bandwidth, etc. The vault 12 is shown with various player functions F1 Quicktime (slow and fast), F2 Windows, F3 Real and F4 MPEG. Each of these formats, in turn, can be encoded at various bit rates, which affects the quality and download time of the resulting media. Consumption (e.g., viewing) can occur at a customer personal computer (PC) 46. Consumption can be initiated in various ways. For example, video content can be e-mailed, posted to the Internet, received by a set-top box connected to a television, public kiosk, cellular phone/handheld device, etc. User acceptance of the e-mail transmission can be accomplished by providing the user with a single e-mail image, which the user can then select or “click on” in order to initiate downloading or streaming the video content. The system 2 also provides users or subscribers with video-on-demand (VOD). The data center 4 can utilize client interrogation methods for determining the user's bandwidth and available media players, whereupon the content can be transcoded into an appropriate format. By maintaining agnostic video content independent of format and form factors in the video vault 12, the transcoding function can accommodate a wide variety of user systems. For example, Microsoft (Windows Media), Apple (Quicktime) and Real are three of the most common players. Video content can be transcoded into any and all of these formats, and can further accommodate the appropriate bandwidths.

Delayed or non-realtime consumption of audio/video content is often referred to as “store-and-forward”, and is generally consumed in one of two ways: 1) “download” for subsequent play; or 2) “streaming”, i.e. simultaneous downloading and playing. Variations on environment and method consumption techniques are also accommodated by the heterogeneous characteristics of the system 2. Consumption application examples include branded video e-mail, branded video enabled Web sites, pay-per-view streaming, transcoding clearinghouse, measured delivery/measure response advertising, security surveillance, specialized streaming to cell phones, personal data assistants (PDAs) and other devices and private label set-top box applications.

Content can generally be input in a single format and then automatically precompiled (i.e. converted) into multiple formats without operator intervention for “headless” transcoding. Compression techniques applied to the video content can be determined by the bit rate of the user. The different compression ratios utilized by different systems can thus be accommodated. It will be appreciated that the video content transfer protocol is account deterministic. In other words, the video player present on the user's system, together with the available bandwidth, automatically determine the format of the transferred video content. The system 2 auto-provisions its resources in order to most efficiently accommodate the multiple format demands made by the large and varied video contents uploaded by various users.

VI. Client/Content Provider Interface

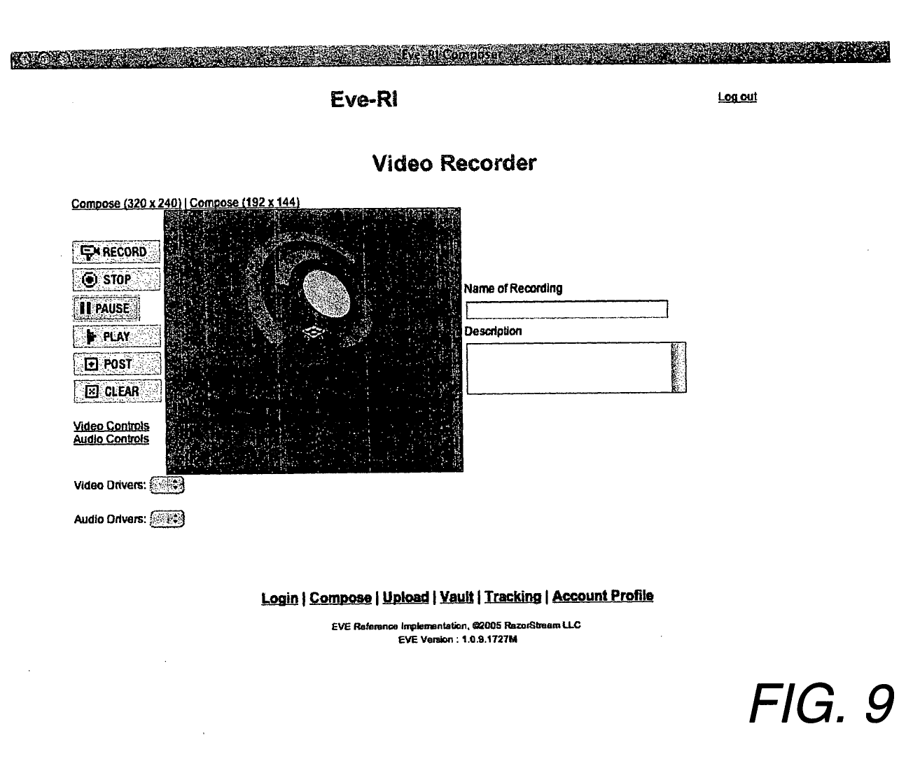

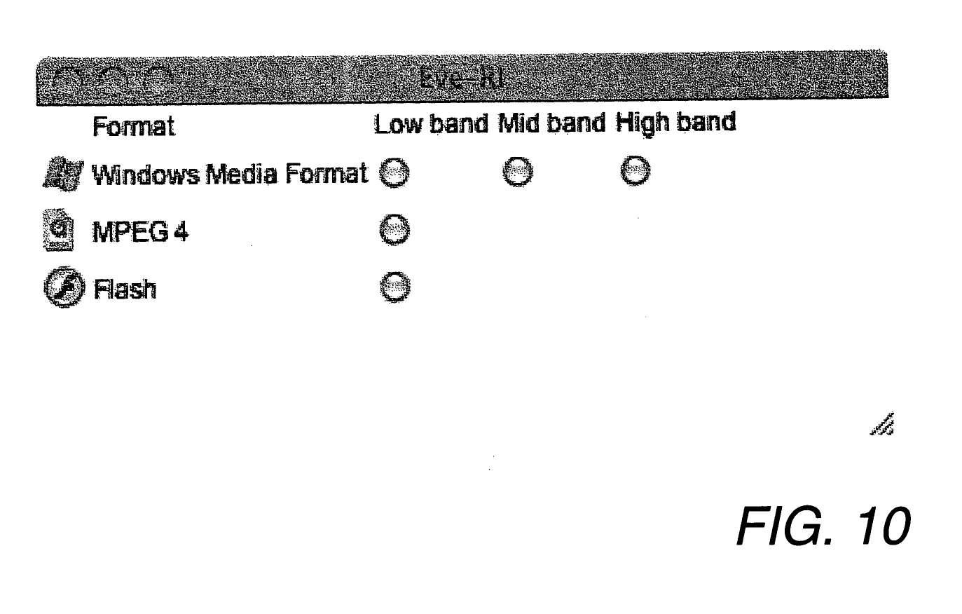

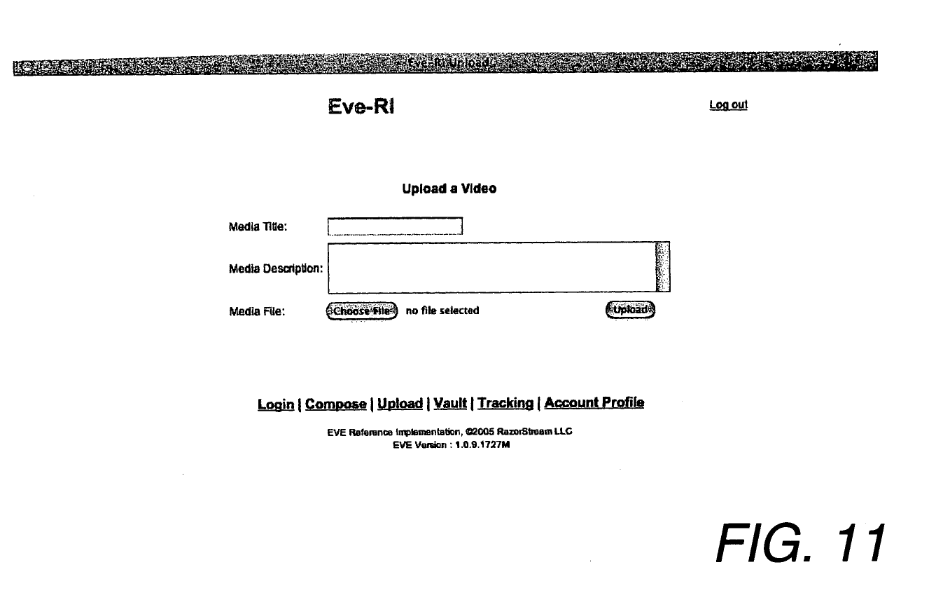

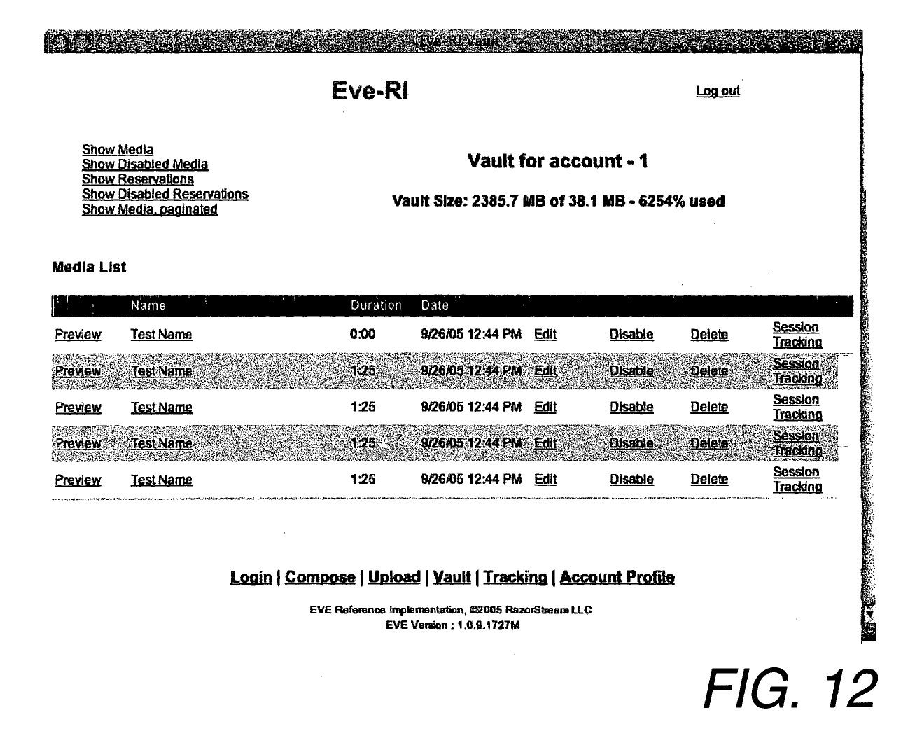

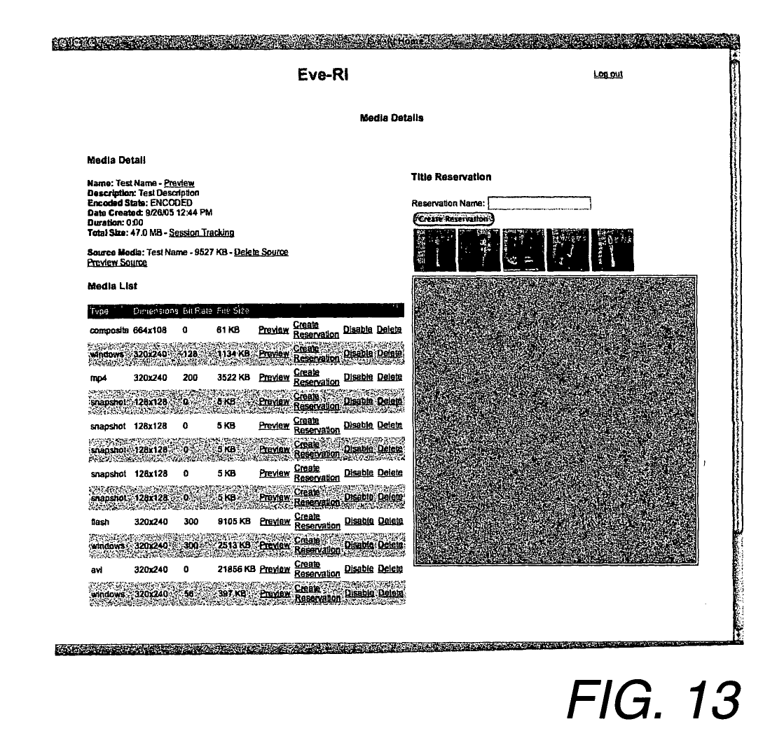

Various functionalities of the system 2 will be described in connection with examples of screen displays, which can provide an interface for clients and content providers. FIG. 9 shows an EVE reference implementation (RI) video recorder screen including various recording functions, with choices for video and audio drivers. FIG. 10 shows an EVE RI screen with applicable media format and bandwidth options, which define the options for transcoding the video content. FIG. 11 shows an EVE RI video upload screen. FIG. 12 shows an EVE RI vault screen displaying a media list. FIG. 13 is an EVE RI media details screen, including viewable media formats (“Type”), dimensions, bit rate and file size.

A content “reservation” function involves naming a vault location with an alias, which provides a level of abstraction for repeatedly providing users with the content of the alias-named video vault location, which content is independent of the alias and can change regularly. For example, daily video content, such as news, sports and weather, can be pointed to with a reservation or alias, which can remain constant while the underlying content is regularly updated through a simple interface. Thus, the contents of a reservation/alias location named, for example, “Daily News, Sports and Weather” can be updated daily at the same location in the vault for direct viewing daily under the same name. The alias eliminates the need to rename the content with each update. A subscriber or end user would thus receive the current reservation content on a daily (or other regular) basis. The reservation allows the content to be named independently of its purpose. The vault 12 can be loaded with a numbers of reservations, which can be controlled by the clients/content providers through appropriate screens, such as FIG. 13.

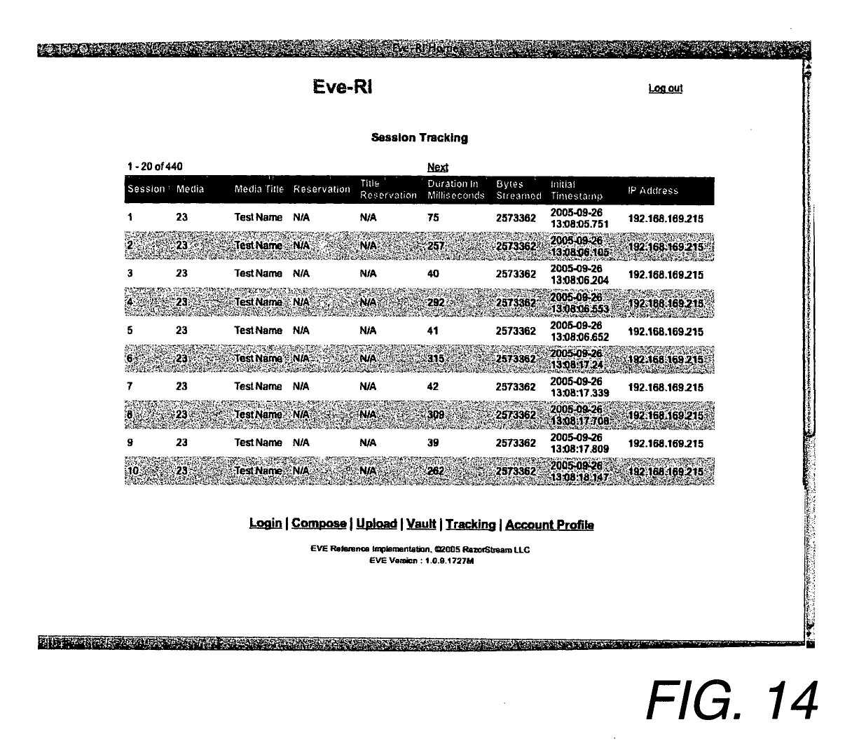

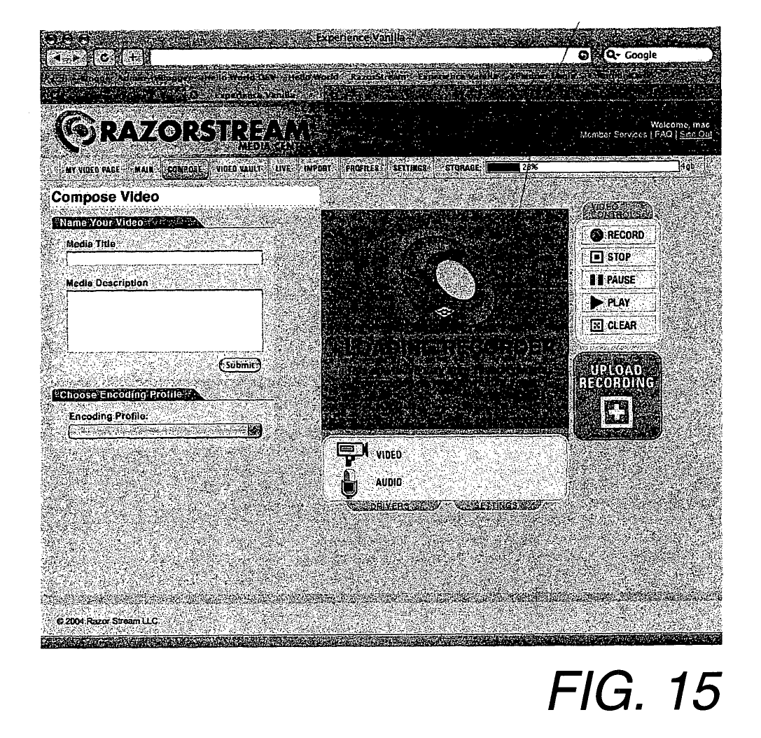

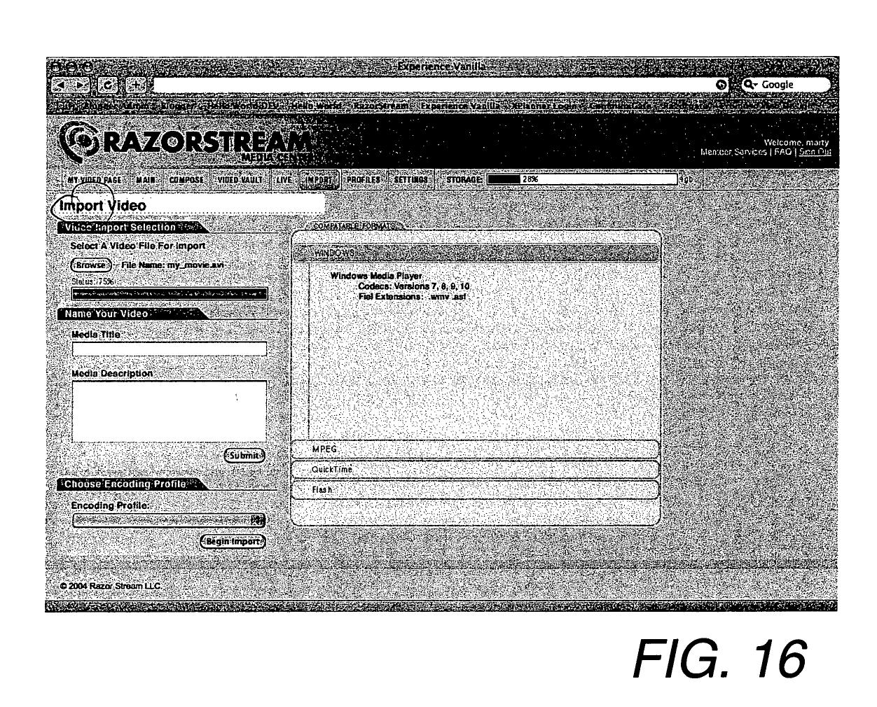

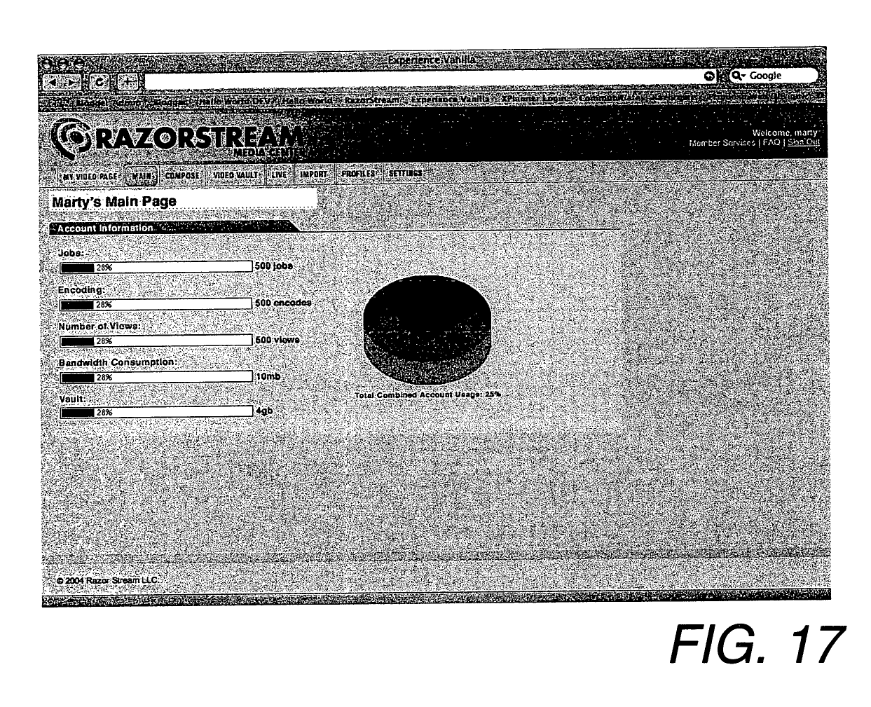

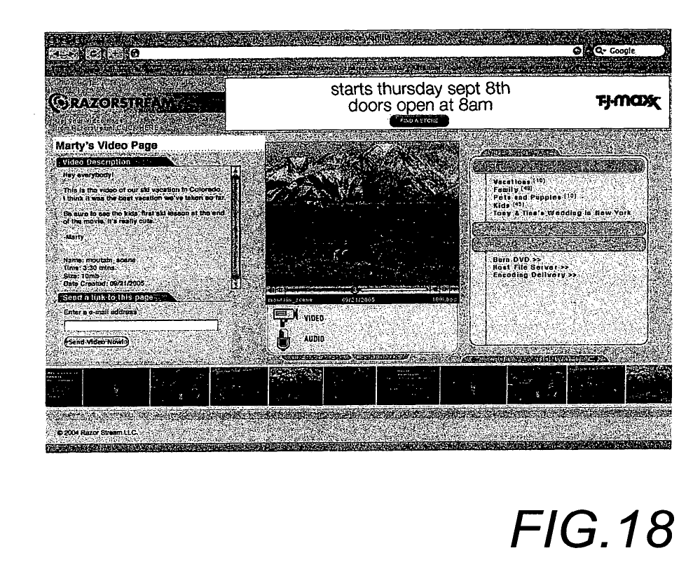

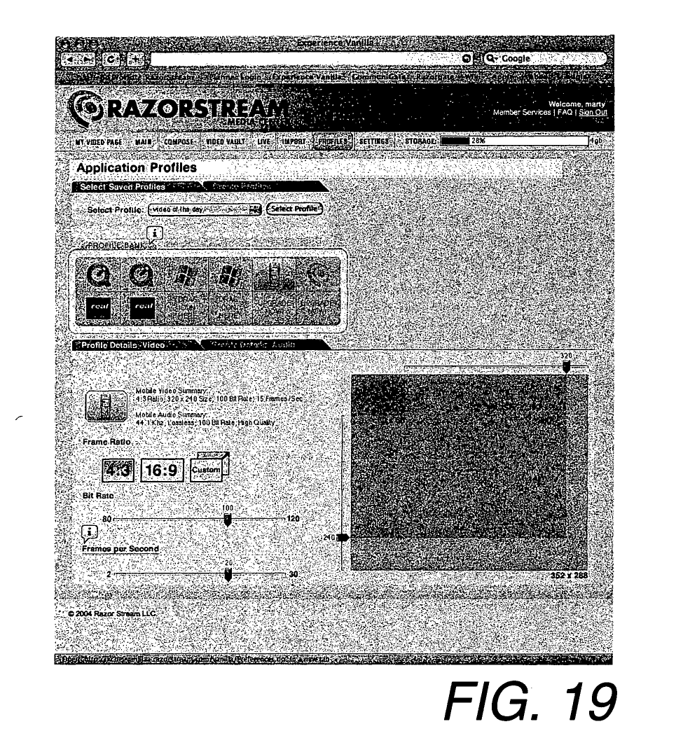

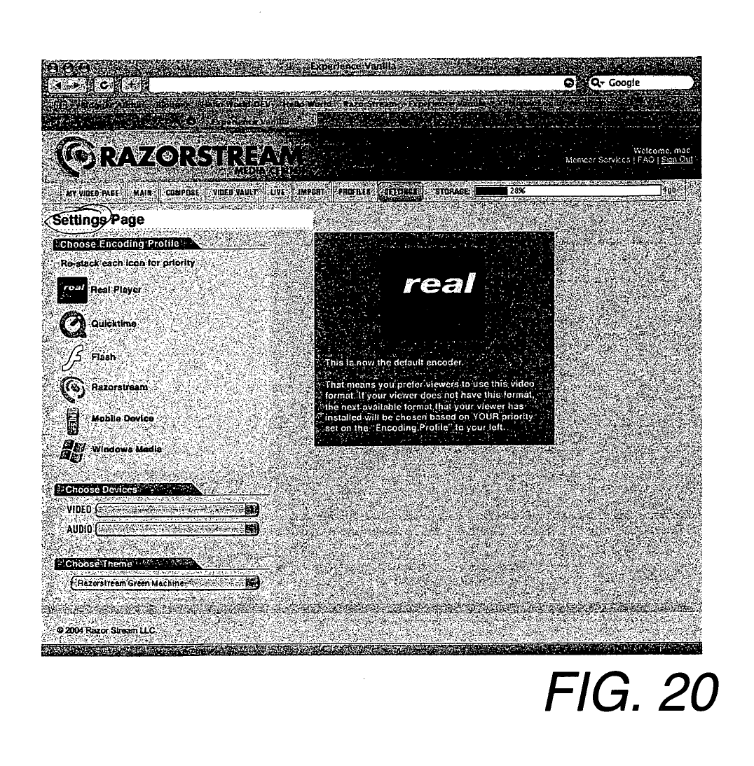

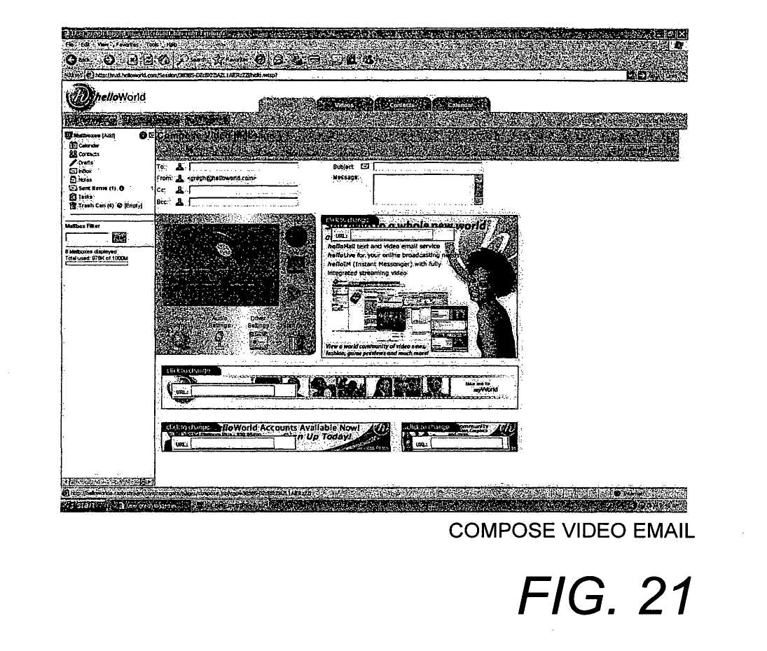

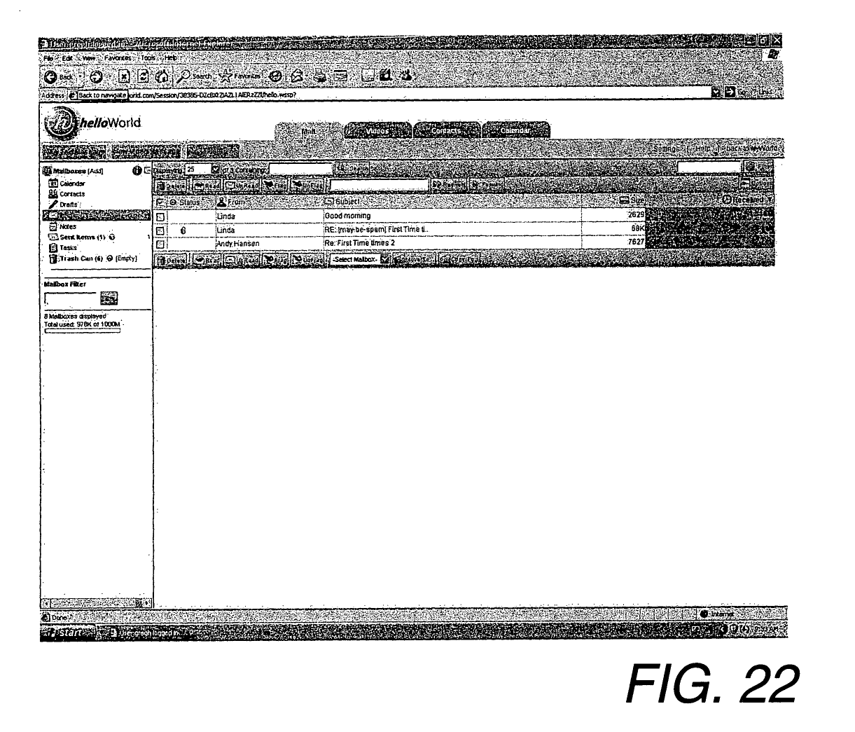

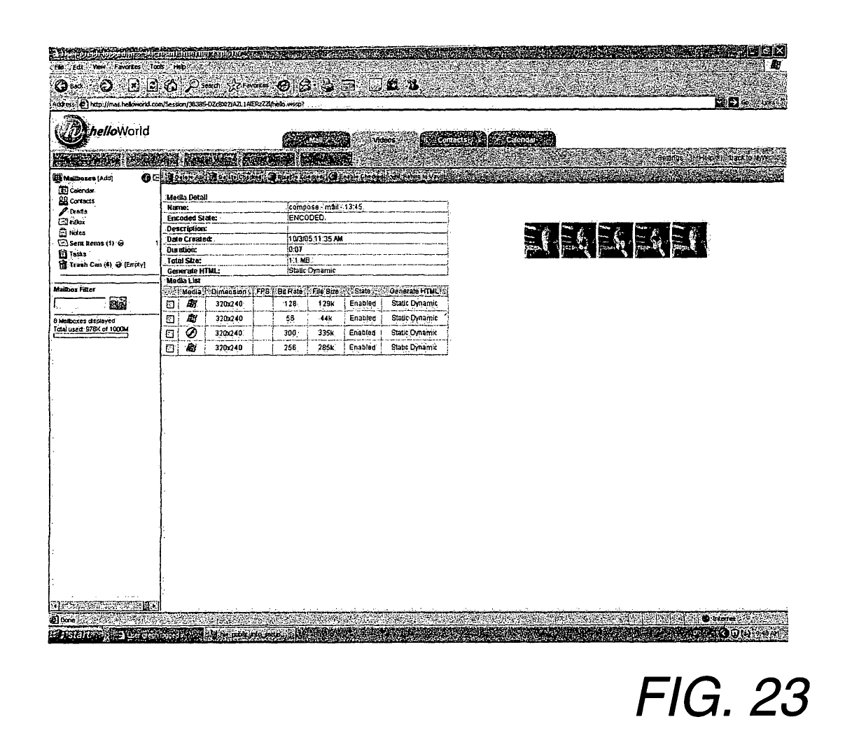

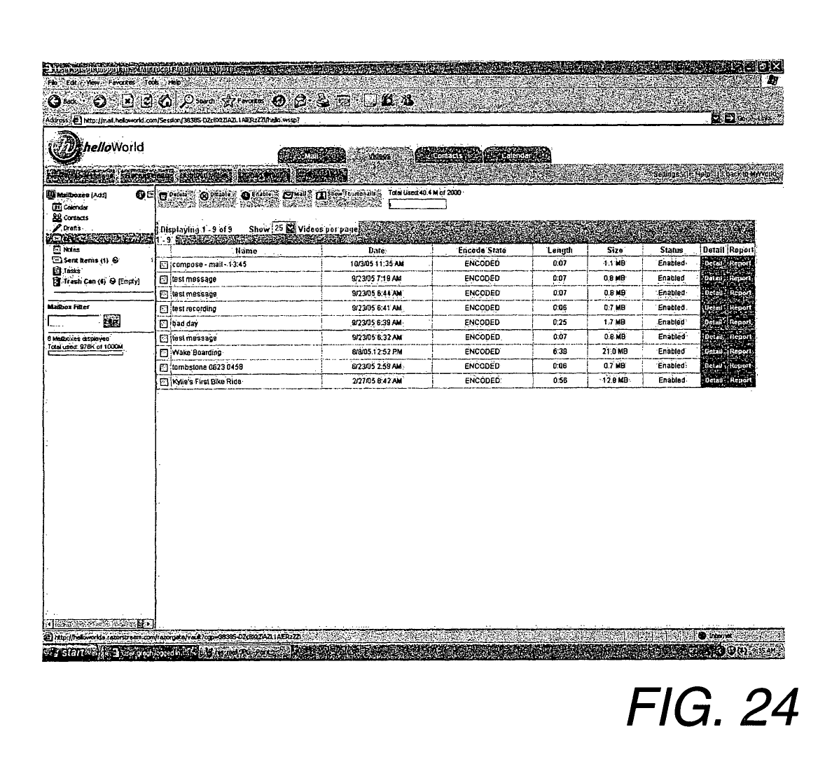

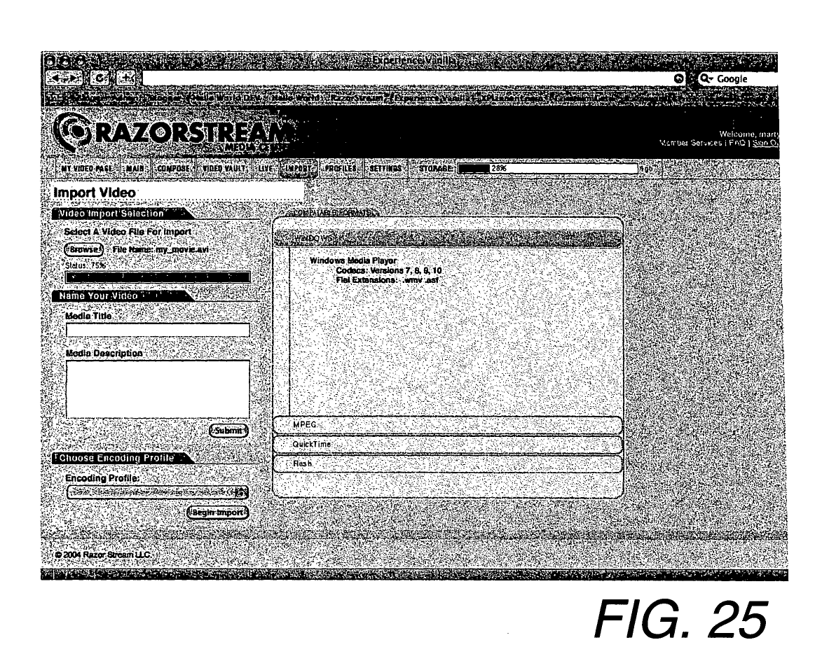

FIG. 14 shows an EVE RI session tracking screen, which can be used by content providers in connection with tracking utilization and viewing. Video content can be either uploaded or recorded for storing in the vault 12. FIG. 15 shows a video-on-demand (VOD) screen for composing, loading and recording content according to an encoding (transcoding) profile selected by the provider. FIG. 16 shows a screen for importing existing video, which also includes an encoding (transcoding) profile menu. FIG. 17 is a screen showing vault utilization and various account information parameters, which can be utilized by an account for managing and reporting purposes. FIG. 18 is a screen for video description, which can comprise a “video page” for an account/content provider. FIG. 19 shows a screen for controlling application profiles. FIG. 20 shows a screen for controlling settings, including an encoding (transcoding) profile. FIG. 21 shows a screen for composing video e-mail. FIG. 22 shows an e-mail inbox. FIG. 23 shows a media detail screen. FIG. 24 shows the vault contents. FIG. 25 shows an import video screen for use by accounts in connection with loading videos to the server 12.

VII. User Interface

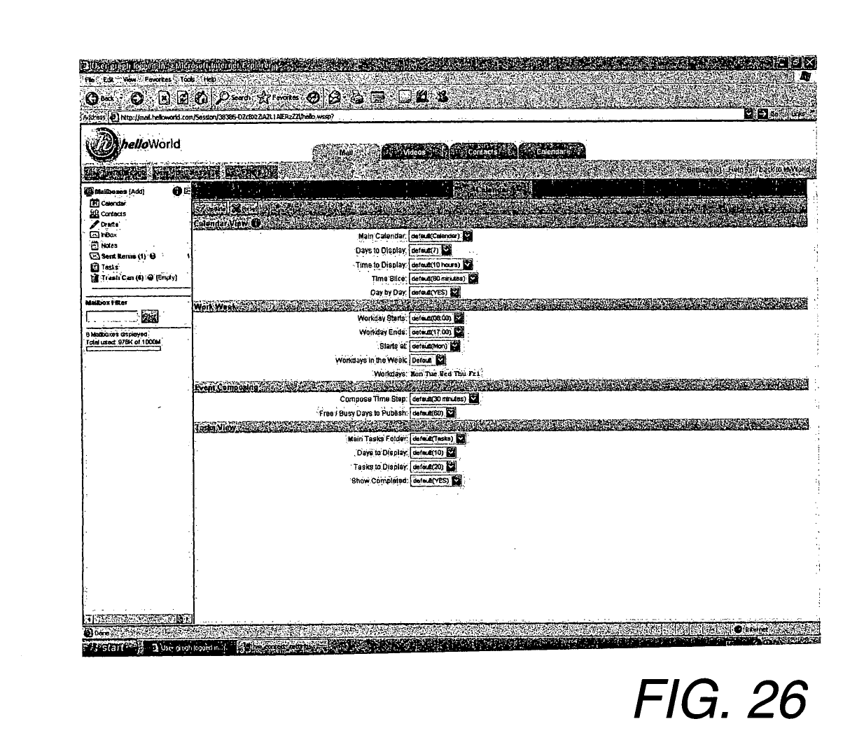

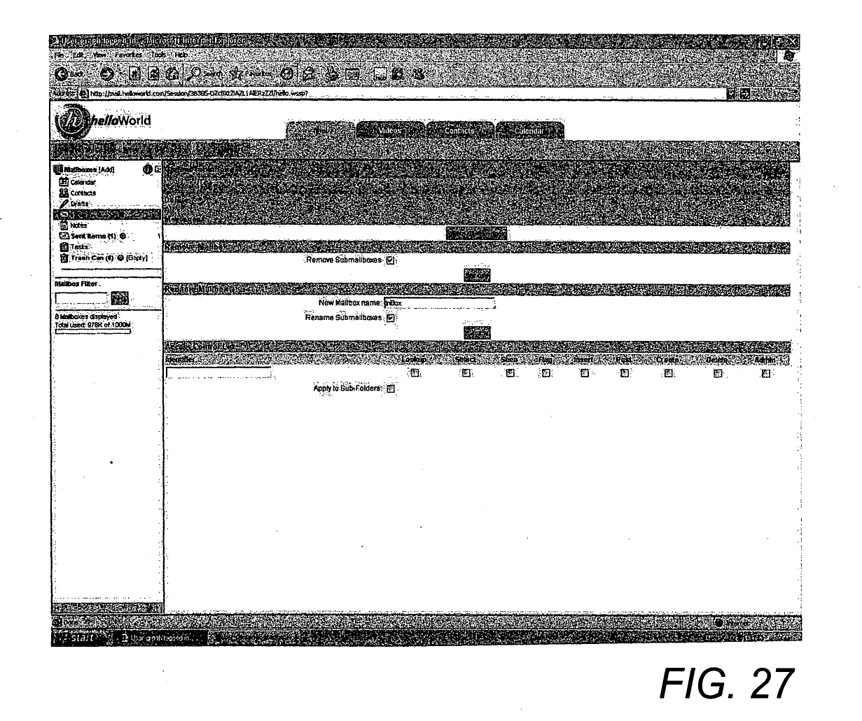

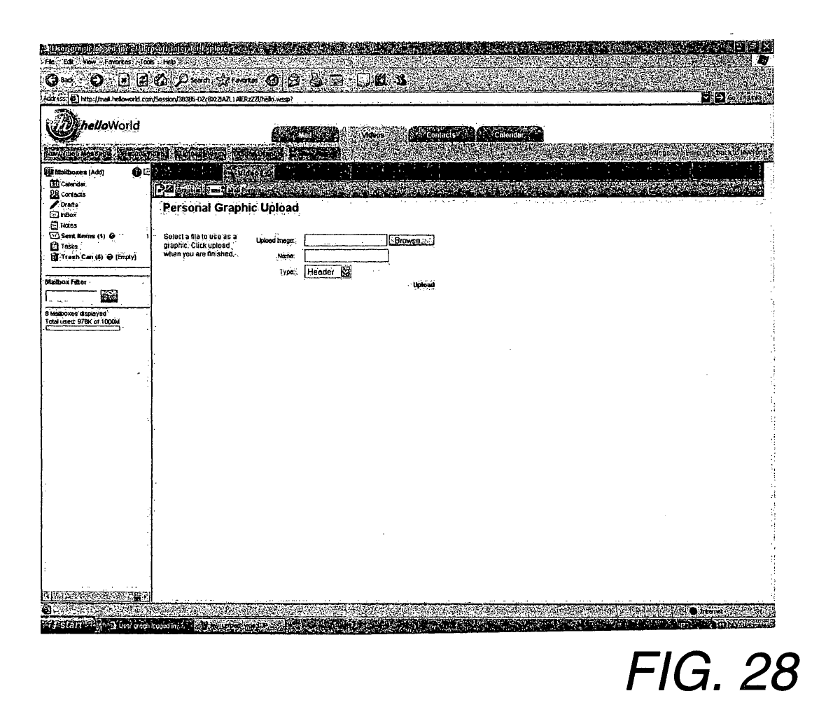

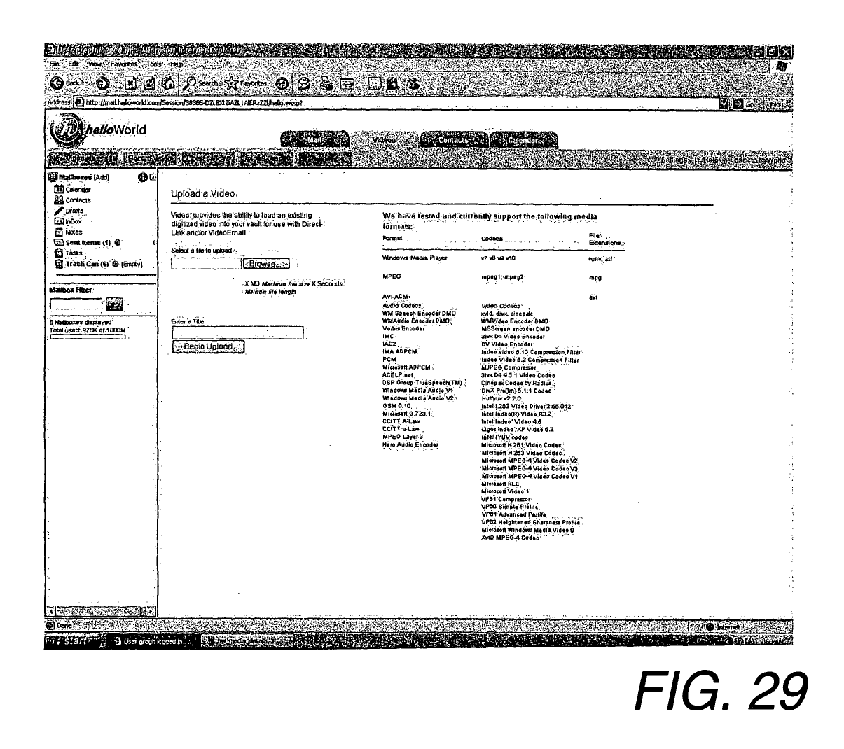

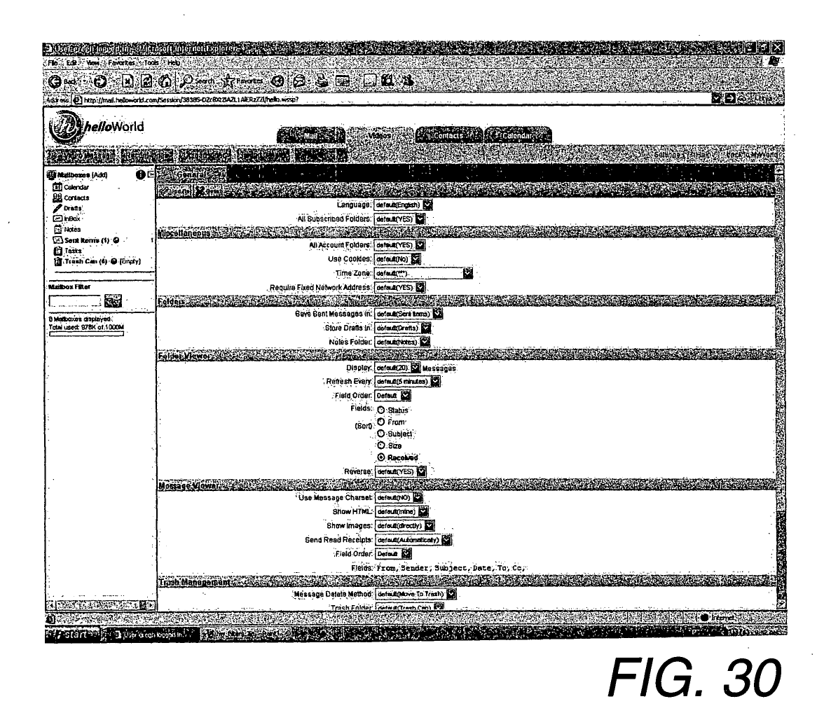

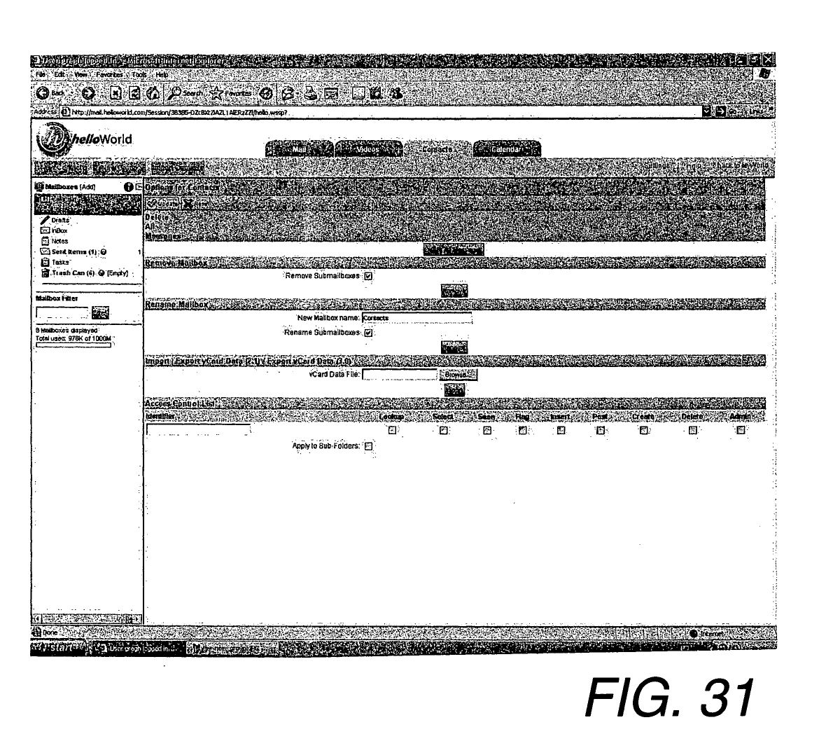

It will be appreciated that accounts, content providers and users can comprise the same entities. FIG. 26 shows a calendar creation/modification screen for use by a viewer. FIG. 27 shows options for an inbox. FIG. 28 shows a personal graphic upload. For 29 shows a screen for uploading a video, including options for format and codes. FIG. 30 shows a screen for video content management. FIG. 31 shows a screen for contact options.

The following products embodying the present invention are described for purposes of illustration and example only, and are not be construed as limiting.

VIII. Application Service Providing (ASP) Product Example

The ASP product provides a centrally managed datacenter storage and streaming solution for all account-based subscriptions. This can expedite the enablement of multimedia offerings. An ASP server farm consists of a multi-tiered server cluster, including the blade computers 9 and the auto provisioning computer components of the server 5, which collectively facilitate the scalability of the system 2 and resource allocation (auto provisioning) whereby computer resources are matched with the tasks required by certain applications for specific accounts. It provides not only web application interaction, but also distinguishes itself in its ability to provide computationally intense transcoding operations server side. The core technology of the data center 4 includes the ability to transcode on demand, for target audience intended to share media.

IX. Multimedia Web Application Utility Product 18 Example

This utility can be provided for account subscribers, and rapidly enables the full suite of features in the system's core libraries. It includes features that are provided in the service and SDK products. In many cases, it may be a full feature set required for an end user, a utility for a developer to get started, or a sales tool for someone to comprehend the system technology.

The web application utility product 18 can be provided for the accounts of the system 2 and can take on multiple roles, including video on demand (VOD) system, web-based encoder and podcasting studio. The Web application utility product 18 can be provided with five main areas of categorization of media functions: 1) creation; 2) management; 3) distribution; 4) publishing; and 5) transcoding. They are described in more detail below.

1. Media Creation

The following procedures can be utilized for media creation:

a) Record a video inside a web browser. Capture video from any live source device attached to a PC. It is compliant with almost all Windows capture devices, e.g. video capture boards, web cams, audio, analog microphones with soundboards and USB microphones, headsets, Bluetooth devices, device drivers compatible with video for Windows, WDM and DirectX.

b) Upload an existing digitized media file via standard http multi-form protocol. Web application utility 18 technology enables the system 2 to allow for various formats and codec compliance. Preferably this is not operating system or browser specific. Both uploading techniques allow the selection of an encoding profile on the same process as the upload. For example, a user can target an upload to be optimized for IPOD playback, or general PC sharing, or both. Encoding profiles can be added in real time to extend the target formats and codecs. The user is in control by being able to select the encoding profile on every upload. The user can set the default profile on the settings page.

c) Using an Appliances Development Kit (ADK), which can be based on an accelerated embedded video/audio processor platform, embedded video appliances and wireless devices can be used for creating video content. Such content can be directly captured, edited and uploaded to the video vault 12. Uploading techniques allow selecting encoding profiles using the same process as the upload. For example, an upload can be targeted to be optimized for IPOD playback, general PC sharing or both. Existing profiles can be used and new files can be added as needed.

2. Media Management (Video Vault)

The following discussion identifies, by way of non-limiting example only, a number of steps that can be involved in managing media.

Review video (get information about a video), including: preview video; read video metadata (date created, filesize, formats/codecs encoded, name, descreption, etc.); report on a video with rated records; create a folder; move a video to a folder; delete a video from a folder; delete a folder; disable a video; and enable a video.

Organize media by group. In the web application utility 18, groups are used to organize media. They are used to make media public or private. Groups can be used for a practically unlimited amount of other business rules for an end application to determine. Media can be assigned to 0+ unlimited groups.

Encoding profile management.

Preview profile settings.

Save personal default settings, including: edit player detection order (set preferred player for playback by viewer); set default video device (for those with more than 1); set default audio device (for those with more than 1); set preferred encoding profile; and set preferred graphical theme.

Share media (e.g., “My Videos”). The web application utility 18 provides a public personal web page enabling users to share their media with others over the Internet worldwide web. This feature can be useful to users who do not have their own blogs or web sites, or who don't want to use their own bandwidth, and who copy media files onto their servers. The share media function includes: create new folders (organize public videos by group); move into another folder (drag and drop enabled); drag into garbage (recycle bin) to remove from public view; and edit/rename a folder.

Reservation management. Reservations enable users to publish HTML links one time to a URL, and then without having to change the URL, use the web application utility backend to alter the media that the URL points to in real time.

Reservation example:

1. Create a reservation to location Media 100.

2. Publish the URL onto web page.

3. Change/rotate the video to a different Media 200.

4. Log into web application utility, and edit the reservation to point to another media ID.

5. Repeat as often as necessary.

Using the above procedure, the user does not have to change HTML or the URL on the web page. This provides a very easy technique for a webmaster to manage video content without altering web pages, or complicated database programming for web page creation.

The reservation feature can include the following functions: create reservations; edit existing reservations (e.g., choose another video, or rename it); and delete reservations.

3. Media Publication (webmasters, web developers)

Publishing a video is the act of generating and/or sending a link to the media. Viewers can be referred to see the URL of a page (e.g., “My Video”) hosted by the system administrator, or HTML can be generated (reservation or media) to cut and paste in subscribers' web pages, or bloggers.

Publishing provides the following features: publish a URL to My Video page and auto play a media; publish an HREF with an image to media; publish an HREF with an image filmstrip; generate HTML to cut and paste into a third party web page or server (e.g., embedded into an iframe or generating a popup window for playback).

Live video streaming (live full screen chat) can include the following steps and features: put video recorder into surveilance mode (security camera); and video phone to another subscriber (full screen mode, low latency).

An RSS feeder can be provided for use in connection with the media publication function.

4. Media Distribution and Playback

When the URL is resolved by the target device, the system 2 has the ability to intelligently select the appropriate player to provision to target a viewer or movie URL if the target device initiates its own player object.

An automatic player detection hint feature enables a subsriber to set hints for the server to try to resolve the player detection of the target device based on their preference. The viewer has the ability to override the automatic decision made by the server, if he or she chooses. The list of options is provided to the viewer during playback. The player preference can be preset by the video content publisher, which presetting can be overridden by the viewer.

An automatic bitrate detection feature can be utilized during encoding profile selection, whereby the subscriber preprograms the transcoder to pre-encode media files in multiple bitrate options to best match the user real time requirements during playback. The server will perform a bitrate test (unless a cookie is detected from a previous request) to determine the best match to the viewer of the currently available media bitrates available. The bitrate selection feature can be overridden by a viewer.

5. Media Transcoding

Transcode processing in multiple digital formats is an important web application utility because it provides very flexible inbound media upload compatibility. Regardless of what media type is uploaded, multiple output formats are available. Each upload can be targeted for playback or download sharing by a multitude of target devices. The system 2 can relieve the video content provider of concerns and constraints based on player-specific format, bitrate and other limitations associated with the end users and viewers of the video content uploaded to the system 2. This allows for multiple encoding profiles to be selectable at time of upload, for purposes of distribution to target viewers.

Without limitation on the generality of hardware, firmware and software equipment and components capable of supporting functions of the system 2, examples of systems compatible with the media transcoding functions include: PC platforms (e.g., Windows, Mac, Unix), IPOD devices, personal video players, personal video players, settop boxes, wireless devices, cell phones, PDAs, telematics, handheld devices, embedded appliances (e.g., kiosk, video camcorders, “thin” clients and smarthome media appliances).

Transcoding makes the source media device or creation much more extendable. The content creator can record on a camcorder, pocketcam, pc/webcam, tivo, video editor. Many of these devices normally produce only single-format output, which could significantly limit or restrict the potential user/viewer base absent the transcoding function of the system 2. Such single-format output limits the ability to share the media by default, or adds many other steps to making target viewers compatible. By web application utility abstracting the complexity of a technical set of trancoding rules, users can just upload their video contents for publication to multiple viewers via the system 2, with a high probabilty of successful playbacks with multiple players having different formats and bitrates. All uploaded files can be processed and transcoded to unlimited available media formats and codecs. Desired formats can be selected by encoding profiles either during uploading or on demand after the upload and with the contents in the vault 12.

X. Eve Services Software Development Kit (SDK) 20 Product Example

Eve services is a web-services/SOAP offering, which can be utilized by any subscriber of one or many accounts. It allows third party developers to create a thin multimedia web application, deferring all complex multimedia processing to be done by the system 2 and its backend service farm. Eve services can reduce time-to-market for third party developers that want to multimedia-enable their new or existing applications.

The SDK has the 5 main areas of categorization:
1. Media Creation—simplify the creation of personal or professional media files
2. Media Management—centrally store and manage media
3. Media Distribution—provide playback streaming/download functionality from vault.
4. Media Publishing—invite/announce media sharing to others
5. Media Transcoding—schedule media transcoding to other formats/bitrates/codecs

These features enable third party application developers to concentrate more on business rules of their vertical spaces, as opposed to spending time trying to master the complex rules of multimedia development. A third party developer can rapidly prototype, and surgically implant one or all of the features of the SDK without a language dependent requirement. Such services can effectively bridge dissimilar technologies to efficiently intercommunicate, thereby enabling skill sets to be maximized independent of the vendor/partners' technology choices. The system 2 provides an SDK to create, manage, distribute, and publish multimedia content.

It is to be understood that the invention can be embodied in various forms, and is not to be limited to the examples discussed above. Other components and configurations can be utilized in the practice of the present invention.

Having thus described the invention, what is claimed as new and desired to be secured by Letters Patent is:

1. A multi-format data coding, managing and distribution system, which comprises:
a data center with a server including a transcoder; and
said server being adapted for receiving data uploads in multiple formats, transcoding said data into other formats and providing access to said transcoded data.

2. The system according to claim 1, which includes:
said data center including storage and streaming solutions for account-based subscriptions; and
said server including a multi-tiered server cluster providing web application interaction and transcoding on demand for target audiences receiving shared media content.

3. The system according to claim 1, which includes:
said system being adapted for coding, managing and distributing data comprising video content.

4. The system according to claim 3, which includes:
said server transcoder converting files among multiple formats and accommodating user appliances with different bitrates.

5. The system according to claim 3, which includes:
said data center including a web application utility adapted for providing one or more functions chosen from the list consisting of: media creation, media management, media distribution, media publishing and media transcoding.

6. The system according to claim 5, which includes:
data storage comprising a vault connected to said server.

7. The system according to claim 4 wherein said data center includes:
an extensible video engine (EVE) providing one or more services chosen from the list consisting of: reporting, web application utility, software development, sampling, testing and e-commerce.

8. The system according to claim 3 wherein said data center includes:
a video vault connected to said server and comprising a storage device adapted for storing and managing video content.

9. The system according to claim 1, which includes:
said data center comprising a primary data center;
a third party data center connected to said primary data center server via a web services function thereof, the worldwide web (Internet); and
said third-party data center including multiple heterogeneous applications of said system.

10. The system according to claim 1, which includes:
said server including multiple blade computers and scalable by adding or removing blade computers thereto or therefrom; and
each said blade computer having a specific function.

11. The system according to claim 6, which includes:
said media creation function including video content recording, capture, uploading and direct capture, editing and uploading to the data center vault.

12. The system according to claim 6, which includes:
said media management function including encoding profile management for personal default settings, player detection, encoding format settings and content sharing functions with access to content in said vault.

13. The system according to claim 6, which includes:
said media management function including a reservation feature whereby a HTML links to a URL and video content associated the web site can be edited without altering the HTML.

14. The system according to claim 6, which includes:
said web application utility including a media publishing function for generating and/or sending a link to media content, referring viewers to a URL and autoplay of media content, live video streaming.

15. The system according to claim 6, which includes:
said web application utility including a media distribution function with features including automatic player format detection and automatic player bit rate detection.

16. The system according to claim 6, which includes:
said web application utility including a media transcoding function for the preceding media uploads of various types and formats and targeting said uploads for playback or download sharing by multiple target devices with different format and bit rate capabilities.

17. The system according to claim 6, which includes:
said transcoding feature making video content from multiple types of media devices usable by viewers with one or more of PC platforms, IPOD players, personal video players, settop boxes, wireless devices, cell phones, PDAs, telematics, embedded appliances, kiosks, video camcorders, thin clients, and media appliances.

18. The system according to claim 17, which includes:
said desired formats are selected by an encoding profile.

19. The system according to claim 3, which includes:
an EVE services feature providing media uploading with profile requests for transcodes, transcode profile management for resolution, bitrate and audio/video compression codecs, and globally sharing media using URL techniques including automatic player format and bitrate interrogation and detection.

20. The system according to claim 3, which includes:
said data center including a web application utility with a media property rights management feature including reporting and accounting functions.

21. A multi-format data coding, managing and distribution system, which comprises:
a primary data center including: a multi-tiered server farm including a transcoder and multiple blades, said server being adapted for adding additional blades or removing blades therefrom for scalability;
said primary data center including a video vault connected to the server for storing and managing video content and a database connected to the server;
said primary data center including reporting, web application utility, software development, sampling, testing and e-commerce functions;
said web application utility providing video on demand (VOD), web-based encoding and podcasting studio services and including media creation, media management, media distribution, media publishing and media transcoding functions;
said server transcoder converting files among multiple formats and accommodating user appliances with different bitrates;
said primary data center including an extensible video engine (EVE) connected to said server and providing one or more services chosen from the list consisting of:
reporting, web application utility, software development, sampling, testing and e-commerce;
a third party data center connected to said primary data center server via the web services function thereof, the worldwide web (Internet);
said third-party data center including multiple heterogeneous applications of said system;
said media creation function including video content recording, capture, uploading and direct capture, editing and uploading to the primary data center vault;
said media management function including encoding profile management for personal default settings, player detection, encoding format settings and content sharing functions with access to content in said vault;
said media management function including a reservation feature whereby a HTML links to a URL and video content associated therewith can be edited without altering the HTML;
said web application utility including a media publishing function for generating and/or sending a link to media content, referring viewers to a URL and autoplay of media content, live video streaming;
said web application utility including a media distribution function with features including automatic player format detection and automatic player bitrate detection;
said web application utility including a media transcoding function for the preceding media uploads of various types and formats and targeting said uploads for playback or download sharing by multiple target devices with different format and bitrate capabilities;
said transcoding feature making video content from multiple types of media devices usable by viewers with one or more of PC platforms, IPOD players, personal video players, settop boxes, wireless devices, cell phones, PDAs, telematics, embedded appliances, kiosks, video camcorders, thin clients, Smart home media appliances;
an EVE services feature providing media uploading with profile requests for transcodes, transcode profile management for resolution, bit rate and audio/video compression codecs and globally sharing media using URL techniques including automatic player format and bit rate interrogation and detection; and
said data center including a web application utility with a media property rights management feature including reporting and accounting function.

22. A method of multi-format data coding, managing and distribution, which comprises the steps of:
creating media including video content;
uploading said media to a data center including a server;
managing said media;
distributing said media via playback streaming and download functionalities;
publishing said media to users and viewers; and
transcoding said media into multiple formats with multiple bitrates and codecs.
